(19) United States
(12) Patent Application Publication
(10) Pub. No.: US 2005/0204490 A1
(43) Pub. Date: Sep. 22, 2005

(54) Powered toothbrush

(76) Inventors: James Herbert Kemp, Somerset, NJ (US); Al Sprosta, Union, NJ (US)

Correspondence Address: COLGATE-PALMOLIVE COMPANY, 909 RIVER ROAD, PISCATAWAY, NJ, 08855, US

(21) Appl. No.: 11/085,615

(22) Filed: Mar. 21, 2005

Related U.S. Application Data
(63) Continuation of application No. PCT/US03/29493, filed on Sep. 17, 2003.
(60) Provisional application No. 60/412,510, filed on Sep. 20, 2002.

(51) Int. Cl. A46B 5/00

(52) U.S. Cl. 15/22.1; 15/105

(57) ABSTRACT

Magnetic levitation technology is incorporated in a toothbrush to supply power useable to power movable cleaning elements, emit light or sound and other functions. Power is generated by merely shaking the toothbrush.

This application is a continuation of application PCT/US2003/029493, filed Sep. 17, 2003, which claims the benefit of U.S. Provisional Application No. 60/412,510 filed Sep. 20, 2002, both of which are incorporated herein by reference in their entirety.

### BACKGROUND OF THE INVENTION

Toothbrushes containing, or linked to, power sources are known. Power supplied to, or in, a toothbrush is used for many purposes. Principal among those uses is the powering of movable cleaning elements. Some examples of powered cleaning elements are those described in U.S. Pat. Nos. 5,625,916 and 6,347,452B1. In these patents a battery is used to drive a motor that imparts reciprocating, vibrating motion to tooth cleaning elements. Other patents, for example U.S. Pat. No. 4,845,795, describe a toothbrush where a motor imparts rotational movement to cleaning elements. Still others, for example, U.S. Pat. No. 4,333,197 describe a toothbrush utilizing ultrasonic cleaning which is powered by conventional 60 cycle house current.

Other patents describe lighted toothbrushes. For example, U.S. Pat. No. 6,106,294 discloses a battery powered light emitting device (LED). A motion switch reacts to movement of the toothbrush to activate circuitry connecting multiple LEDs to a battery power source. This produces a novelty “twinkle” effect in the toothbrush. U.S. Pat. No. 4,788,734 discloses a battery powered toothbrush with audible signals emanating from the brush timed to correspond with optimum lengths of tooth brushing. Still other powered features associated with toothbrushes are described in U.S. Pat. No. 6,106,294 (See column 1, line 11 to column 2, line 10).

Most of these powered toothbrushes suffer the disadvantage of relying on batteries for power. Battery power poses the problem of sudden loss of power after extended use. Replacement of batteries depends upon ready availability of a fresh battery. Batteries add considerable bulk to the handle for a toothbrush. Batteries can also corrode and destroy the toothbrush.

For sanitary and electrical reasons (avoidance of short circuits), the battery must be sealed in the toothbrush handle. This complicates battery replacement efforts, especially for elderly and juvenile users.

Thus, there is a need for a powered toothbrush that can operate for long periods without need to replace batteries and eliminates the need for access to house current to power the toothbrush (either directly or through a rechargeable power pack).

### SUMMARY OF THE INVENTION

A powered toothbrush is disclosed which contains a self-contained power source that needs no replacement or external power supply. More specifically, the toothbrush of the invention is powered by magnetic levitation technology. In this approach kinetic energy is transformed into electrical energy by repeatedly passing a high field strength magnet through a coil of wire. Resultant electrical energy is stored in a capacitor. Energy is created by simply shaking the toothbrush so that the magnet is moved through the coiled wire.

Magnetic levitation technology has been used to power flashlights. U.S. Pat. No. 6,220,719B1 describes such a flashlight which is powered when the user shakes the flashlight to move a magnet through a coil. The electricity so generated is used to charge a capacitor that in turn powers a light emitting diode (see column 1, lines 43-46). Use of such levitation technology to power a toothbrush is disclosed herein. The use of this approach avoids many of the abovementioned pitfalls of other energy sources used to power toothbrushes.

The ready availability of continuous energy within the toothbrush offers multiple possibilities for toothbrush enhancements. The power generated by simply shaking the toothbrush can, in addition to powering movable cleaning elements, be used to emit light or sound from the toothbrush, provide energy to catalyze special synergistically formulated toothpaste, provide energy for piezoelectric functions or generate UV light for self sanitizing functions.

### BRIEF DESCRIPTION OF THE DRAWING

This invention is capable of use to provide a broad array of powered features in a toothbrush. The drawing illustrates one use of the invention and is not to be construed as the only embodiment of the invention.

FIG. 1 shows the powered toothbrush of this invention.

### DETAILED DESCRIPTION OF THE PREFERRED EMBODIMENT

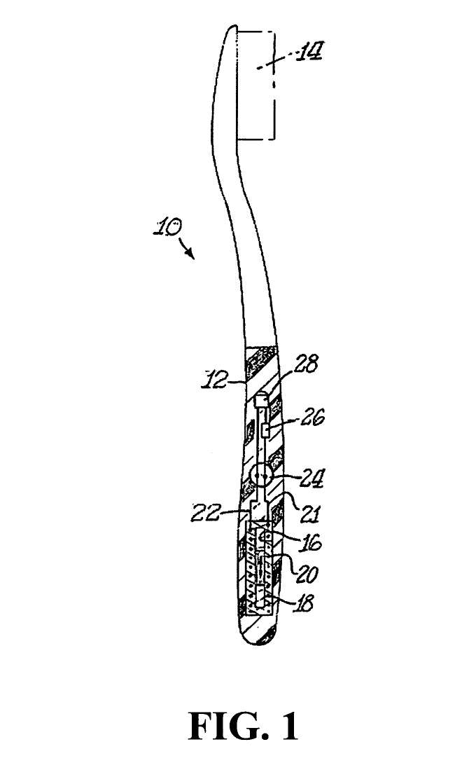

FIG. 1 illustrates one application of magnetic levitation technology in a toothbrush, more particularly, to power a light source (LED) in the toothbrush. As described above, the power generated by the toothbrush can be used for other applications including rotation, reciprocation or other movement of cleaning elements; to emit music; sanitize the toothbrush or other enhancements.

As illustrated, the toothbrush 10 includes a handle 12 with cleaning elements 14 (shown in phantom) at one end. The handle 12 preferably contains a hollowed bore 16. Concentrically arranged within the bore 16 is a wire coil 18 which surrounds a magnet 20. The magnet 20 is free to move in both directions relative to coil 18 as indicated by the arrows in FIG. 1. At either end of travel within the bore 16 springs or repelling magnets (not shown) may be placed to prevent bottoming of the magnet 20 in its travels through the hollowed bore. Wire leads 21 and 22 attached to the wire coil 18 lead to capacitor 24. A bridge rectifier (not shown) may be used in this circuit between coil 18 and capacitor 24 to convert AC input into DC output to the capacitor 24.

The capacitor 24 is electrically connected to LED 28. An LED protection zener diode 26 can be arranged in one lead to capacitor 24 to prevent excessive forward voltage that could damage the LED.

To enhance the effect of light emitted by light emitting diode 28 a portion or all of handle 12 can be transparent or translucent.

To operate toothbrush 10, the user need only shake the handle 12 in a manner that causes the magnet 20 to move back and forth within the hollow bore 16 in handle 12. The energy thus generated is stored in capacitor 24 and discharged as needed to light the toothbrush or operate one or more alternative powered components such as cleaning elements, UV sanitizing element, music or the like. A switch (not shown) may be inserted in the wiring circuit to control the release of power being stored in capacitor 24.

Any suitable form of cleaning elements may be used as the cleaning elements 14 in the broad practice of this invention. The term “cleaning elements” is intended to be used in a generic sense which could include conventional fiber bristles or massage elements or other forms of cleaning elements such as elastomeric fingers or walls arranged in a circular cross-sectional shape or any type of desired shape including straight portions or sinusoidal portions. Where bristles are used, the bristles could be mounted to tuft blocks or sections by extending through suitable openings in the tuft blocks so that the base of the bristles is mounted within or below the tuft block.

1. A powered toothbrush comprising a handle, a head with at least one cleaning element, a powered element and a power generator, wherein power is generated from the power generator by movement of the toothbrush.

2. A powered toothbrush in accordance with claim 1, wherein power is generated from the power generator by shaking the toothbrush.

3. A powered toothbrush in accordance with claim 2, wherein the power generator further comprises a wire coil surrounding a movable magnet, said wire coil being electrically connected to the powered element.

4. A powered toothbrush in accordance with claim 3, further comprising a power storage device disposed between the power generator and the powered element.

5. A powered toothbrush in accordance with claim 3, wherein the power generator is disposed in the handle.

6. A powered toothbrush in accordance with claim 3, wherein the powered element is a light.

7. A powered toothbrush in accordance with claim 3, wherein the powered element further comprises the at least one cleaning element.

8. A powered toothbrush in accordance with claim 3, wherein the powered element is a sanitizing element.

9. A powered toothbrush in accordance with claim 3, wherein the powered element is a sound emitting device.

10. A method of generating power in a toothbrush comprising the steps of providing a toothbrush with a handle, a head and at least one cleaning element, providing a powered element and a power generator in the toothbrush, and generating power from the power generator by moving the toothbrush.

11. A method in accordance with claim 10, wherein power is generated from the power generator by shaking the toothbrush.

12. A method in accordance with claim 11, wherein the power generator further comprises a wire coil surrounding a movable magnet, said wire coil being electrically connected to the powered element.

13. A method in accordance with claim 11, wherein a power storage device is disposed between the power generator and the powered element.

14. A method in accordance with claim 12, wherein the power generator is disposed in the handle.

15. A method in accordance with claim 12, wherein the powered element is a light.

16. A method in accordance with claim 12, wherein the powered element further comprises the at least one cleaning element.

17. A method in accordance with claim 12, wherein the powered element is a sanitizing element.

18. A method in accordance with claim 12, wherein the powered element is a sound emitting device.
